(19) United States
(12) Patent Application Publication
(10) Pub. No.: US 2008/0172089 A1
(43) Pub. Date: Jul. 17, 2008

(54) Pacifier with integral protective nipple housing

(76) Inventor: Melissa J. Fernandez, Santa Barbara, CA (US)

Correspondence Address: M. Reza Savari, Esq., 2262 Caminito Cala, Del Mar, CA, 92014, US

(21) Appl. No.: 11/654,075

(22) Filed: Jan. 17, 2007

(51) Int. Cl. A61J 17/00

(52) U.S. Cl. 606/236; 606/234

(57) ABSTRACT

The present invention relates generally to the field of pacifiers, and particularly to pacifiers with integral protective nipple housing and methods thereof. The present invention is particularly adaptable as a pacifier for comforting an infant's suckling instinct, while being capable of integrally providing a protective nipple housing when the pacifier is not being used in order to keep the nipple from getting dirty. The present invention can also be combined with any type of pacifier attachment bands or strings in order to, for example, attach the pacifier to the infant's clothing so that it will not fall on the floor.

### FIELD OF INVENTION

The present invention relates generally to the field of pacifiers, and particularly to pacifiers with integral protective nipple housing and methods thereof.

### BACKGROUND OF THE INVENTION

All infants have a suckling instinct that lasts for the first years of their lives. This instinct ensures that the infant receives his/her required nutrition. However, infants often have a suckling urge when they are not hungry such as when they are upset or tired. Pacifiers are used to satisfy an infant's non-nutritional suckling instinct in order to comfort them.

A variety of pacifiers are commercially available. Most of these pacifiers currently on the market are made of two different materials. They are usually made of a hard plastic shield and handle and either a silicone or latex hollow nipple. The nipple is hollow to allow it to flex and partially collapse in the infants mouth the way a human nipple does during suckling. The separate pieces are permanently assembled together to form the pacifier. The shield portion usually has holes or slits through it in order to allow air circulation. This prevents skin irritation and/or a “suction-cup” effect that can be caused if saliva gets between the shield and the infant's face when suckling the pacifier.

Many of the available cushions are not effectively constructed in protecting against separation of the pacifier pieces and many do not provide for a protective nipple housing in order to keep the pacifier clean when it is not being used by the infant. Current pacifiers have several design defects.

First, the nipple and shield portion can become separated either through intended use by the infant or by unintended use by the infant or parent. One common way a nipple may become separated by the infant occurs once the infant begins to teethe. During this time he/she will sometimes chew on the pacifier rather than suck on it for comfort. The infant will hold the pacifier by the handle and twist it around in his mouth while biting the nipple portion. Another way the nipple may become separated is when the parent washes it too vigorously. When the nipple portion becomes separated from the hard plastic shield water or saliva can get into the hollow nipple. The water or saliva can never be removed and mold forms in the pacifier nipple, ruining it. Even if mold does not form in the nipple the water or saliva infected pacifier makes a loud squishing sound when suckled, hence preventing the infant from falling asleep while suckling it. A separated nipple can also be a choking hazard if the nipple becomes totally separated, and can pinch the infant's lips or tongue if not totally separated.

Second, because water can enter the hollow nipple portion, current pacifiers cannot be completely sterilized such as in boiling water, submerged in dish water, and/or washed in a dishwasher. Hence, they cannot be reused by passing them on to another child for use and must be thrown away, causing unnecessary waste.

Third, infants regularly drop or throw their pacifiers on the ground causing them to get dirty. Hence, a separate case is needed to keep the pacifier clean regardless of where the pacifier is being stored, such as in a purse, diaper bag, or at home. Some pacifiers have cases or lids that fit over the nipple. However, cases and lids get lost or broken, making them less convenient than intended. Additionally, cases are too bulky to be carried in a pocket. Even when pacifiers are left hanging on a pacifier string attached to the infant's clothes, the nipple portion of the pacifier is still exposed and it continues to get dirty with the infant's movement, such as crawling. It should also be noted that some pacifiers, by design, cannot fit into pacifier cases or cannot be fitted with lids, hence there is no way to keep them clean. This is very frustrating as it is almost impossible to wash a pacifier off every time it is dropped or touches something dirty, and pacifiers get dirty about 20 or more times per day! While there has been a trend to produce more effectively constructed pacifiers and pacifiers with protective lids for the nipple, further improvements in effectiveness, convenience, safety and cleanliness of pacifiers is desirable, and the present invention addresses the existing problems and provides related solutions and benefits.

### SUMMARY OF THE INVENTION

The present invention relates generally to the field of pacifiers, and particularly to pacifiers with integral protective nipple housing and methods thereof. The present invention is particularly adaptable as a pacifier for comforting an infant's suckling instinct, while being capable of integrally providing a protective nipple housing when the pacifier is not being used in order to keep the nipple from getting dirty. The present invention can also be combined with any type of pacifier attachment bands or strings in order to, for example, attach the pacifier to the infant's clothing so that it will not fall on the floor.

The present invention recognizes that pacifiers can be kept cleaner and more hygienic in a more convenient and effective way by providing an integrally constructed protective nipple housing.

A first aspect of the present invention includes a pacifier including: a) a nipple including a first end and a second end, the first end including a substantially round shape; and b) a generally planar and substantially flexible shield including a top side and a bottom side, the top side of the shield being attached to the second end of the nipple, wherein the nipple is generally attached at the center of the top side of the shield, the shield including a right region and a left region, the right region and the left region of the shield including one or more means for reversible attachment to each other, wherein the right region and the left region of the shield are able to be brought in close proximity to each other and surrounding the nipple, whereby the right region and the left region of the shield are able to reversibly attach to each other by way of the one or more means for reversible attachment providing a covered housing for the nipple.

A second aspect of the present invention includes a pacifier including: a) a substantially round nipple comprising an elongated body integrally forming a generally planar and substantially flexible shield, the shield including a right region and a left region that extend away from the nipple, wherein the right region and the left region are capable of being brought in close proximity to each other and surrounding the nipple; and b) one or more means for reversible attachment capable of attaching the right region and the left region of the shield to each other providing a covered housing for the nipple.

### BRIEF DESCRIPTION OF THE DRAWINGS

FIG. 1 shows a perspective view of an embodiment of the present invention.

FIG. 2 shows a side view of an embodiment of the present invention.

FIG. 3 shows a top view of an embodiment of the present invention.

FIG. 4 shows a side view of an embodiment of the present invention in closed configuration with the shield providing a covered housing for the nipple.

### DETAILED DESCRIPTION OF THE INVENTION

### Introduction

The present invention recognizes that pacifiers can be kept cleaner and more hygienic in a more convenient and effective way by providing an integrally constructed protective nipple housing.

As a non-limiting introduction to the breadth of the present invention, the present invention includes several general and useful aspects, including:

1) A pacifier including:
a) a nipple including a first end and a second end, the first end including a substantially round shape; and
b) a generally planar and substantially flexible shield including a top side and a bottom side, the top side of the shield being attached to the second end of the nipple, wherein the nipple is generally attached at the center of the top side of the shield, the shield including a right region and a left region, the right region and the left region of the shield including one or more means for reversible attachment to each other, wherein the right region and the left region of the shield are able to be brought in close proximity to each other and surrounding the nipple;
whereby the right region and the left region of the shield are able to reversibly attach to each other by way of the one or more means for reversible attachment providing a covered housing for the nipple.

2) A pacifier including:
a) a substantially round nipple comprising an elongated body integrally forming a generally planar and substantially flexible shield, the shield including a right region and a left region that extend away from the nipple, wherein the right region and the left region are capable of being brought in close proximity to each other and surrounding the nipple; and
b) one or more means for reversible attachment capable of attaching the right region and the left region of the shield to each other providing a covered housing for the nipple.

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

### I. Pacifier With Intergral Protective Nipple Housing

The present invention relates generally to the field of pacifiers, and particularly to pacifiers with integral protective nipple housing and methods thereof.

The present invention includes a nipple including a first end and a second end, the first end including a substantially round shape. The nipple may be preferably hollow to allow it to flex and partially collapse in the infant's mouth similar in the way a human nipple does during suckling. The nipple of the present invention may be constructed orthodontically correct, i.e., designed not to interfere with the growth/development of teeth in the jaw, or it may be constructed more like a natural nipple. The shape of the nipple may be natural nipple shape, bulbous, straight, or any other suitable pacifier nipple shape.

The present invention also includes a generally planar and substantially flexible shield including a top side and a bottom side. The shield of the present invention may be curved to fit closer to the infant's face or be straight. Different nipple and shield shapes are advantageous as every infant is different and prefers a different shape of pacifier. The top side of the shield of the present invention is preferably able to being attached to the second end of the nipple, wherein the nipple is generally attached at the center of the top side of the shield. This type of positioning is preferable because of the symmetry provided with respect to the nipple and the shield. The shield of the present invention may include one or more holes or slits through its body in order to allow air circulation. This helps prevent skin irritation and/or a suction-cup effect that can be caused if saliva gets between the shield and the infant's face when suckling the pacifier. The pacifier of the present invention may be made in any suitable shapes and sizes of to compensate for the infant's growth. The shield size may remain the same, but the nipple size may be progressively made in the larger sizes as the infant's mouth grows.

The shield of the present invention includes a right region and a left region. The Shied of the present invention and the right and left regions of the shield may be in any shape and size suitable for interaction with the infant's face while suckling on the pacifier. The right region and the left region of the shield of the present invention include one or more means for reversible attachment to each other. The means for reversible attachment of the present invention may be any suitable means for the purpose of providing reversible attachment of the right region and the left regions together. It is an important aspect of the present invention that the right region and the left region of the shield are able to be brought in close proximity to each other and surrounding the nipple, and whereby the right region and the left region of the shield are able to reversibly attach to each other by way of the one or more means for reversible attachment providing a covered housing for the nipple. The right region and the left region of the shield should be slightly longer then the length of the nipple so that they would entirely cover the nipple when they are folded shut over the nipple. In a preferred embodiment of the present invention, the right region and the left region of the shield are able to reversibly attach to each providing substantially covered housing for the nipple, however, in some embodiments of the present invention the right region and the left region of the shield are able to reversibly attach to each providing partially covered housing for the nipple. The right region and/or left regions of the shield of the present invention may include one or more curved surfaces, such that when the right region and the left right region of the shield are brought in close proximity to each other a cavity is formed, which can partially or substantially surround the nipple.

The means for reversible attachment may preferably include, for example, one or more protruding tabs on, for example, on the right region, and one or more aperture, for example, on the left region, wherein the protruding tabs are capable of reversibly attaching to the apertures providing a substantially covered housing for the nipple. Other suitable means for reversible attachment may include, for example, reversible fasteners, snap buttons, hooking means, or male-female type means for reversible attachments wherein a male protruding member is able to be inserted and accepted by a female cavity or aperture member for reversible attachments. Preferably the circumference of the male protruding member is about equal to or slightly larger than the circumference of the female cavity or aperture member to ensure a tight yet reversible attachment. The male protruding member may further include an one or more projections, such as an o-ring type projection or other suitable projections on its body, and the female cavity or aperture may further include a circular groove or other suitable grooves within the walls of its cavity or aperture, such that when the male protruding member is inserted into the female cavity or aperture, the projection on the male member also fits into the groove within the walls of the female cavity or aperture providing a stronger reversible attachment means. The male-female type means for reversible attachment, especially the female portion, whether located all on the same side of the pacifier wing, or on each side, would serve not only as a securing device to close the pacifier, but would also provide ventilation as between the shield surface and the infant's face while suckling the pacifier. The present invention may also include one or more mounting means engaged at the outer periphery of the shield and the one or more means for reversible-attachment may be position on the mounting means in order to provide a more rigid and secure protective housing for the nipple. The one or more mounting means may be in the form of a full or partial annular ring, or it may have any regular or non-regular shape desired.

The pacifier or the present invention may further include a handle attached at the bottom side of the shield. The handle may be in any shape, size or design suitable for handing the pacifier when the pacifier is being used, washed, or carried.

The present invention may preferably be a one-piece unitary construction. Although the pacifier of the present invention may include a nipple, a shield, and a handle that are separately made and then assembled together, it is preferable to that the pacifier of the present invention have a one-piece unitary construction. By utilizing a unitary construction design, the pacifier can be made safer by eliminating the choking and/or pinching hazards when the pieces are separable and separate. Moreover, because in a one-piece unitary construction, the nipple would not be susceptible to water and/or saliva penetration, the pacifier can be sterilized in boiling water, submerged in dish water, or washed in a dishwasher. Hence, the pacifier could be passed on to another child, making the pacifier more environmentally friendly. The pacifier of the present invention may be fabricated by any suitable and proper means, for example, use of a single mold which would form the silicone or similar material into one unitary piece, or other fabrication methods such as a casting or other molding procedure such as injection molding, overmolding, transfer molding, or a combination thereof.

The present invention, including the nipple, shield, and handle, may be constructed from any material suitable for the purpose, such as suitable plastics or elastomers or the like with similar pliability, however, it is preferable that the pacifier, be constructed from an elastomeric material. The preferred elastomeric material include silicone, one or more thermoplastic elastomers, or a combination thereof. By providing a unitary constructed pacifier made from silicone or similar material, the entire pacifier becomes more pliable unlike those with a hard plastic shield, and hence, the shield of the pacifier can fold shut over the nipple providing a protective housing. When the right region and the left region of the shield are folded, the pacifier is protected from the elements keeping it clean. In effect, the right region and left region of the shield provide wings for the pacifier, which become the pacifier's case or housing. This eliminates the need for a separate case or nipple shield to protect and keep the pacifier clean. Additionally, when the right and left regions of the shield are folded, the entire pacifier becomes more compact, making storage in a pocket, purse, diaper bag, or attached to a pacifier string more convenient.

Preferably, the present invention will be made using a single mold which would form the silicone or similar material into one unitary piece. It would also be possible to layer silicone over another rubber, which is similar in pliability. Such a layering of rubber material may serve to give the pacifier more stability, which would be beneficial as the pacifier would be folded over and over again throughout its period of use.

When a pacifier with a one-piece unitary construction is made of silicone or a similar material, it would be flexible enough so that the handle portion would be able to twist around or be bent around to the top side of the shield from the bottom side of the shield, in order to further encase the folded pacifier to make it more compact and add extra stability to keep the pacifier closed.

The shield of the present invention may include one or more curved surfaces, such that when the right region and the left right region of the shield are brought in close proximity to each other a housing cavity for the nipple is formed, which can partially or substantially surround the nipple.

### EXAMPLES

### Example I

### Pacifier With Integral Protective Nipple Housing

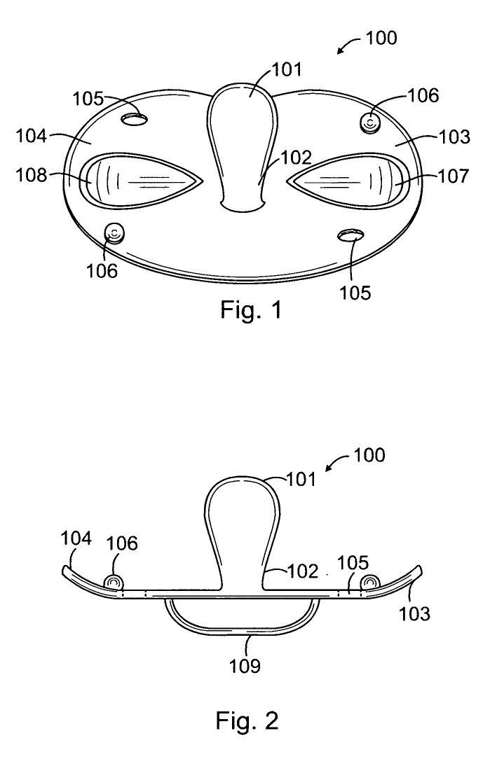

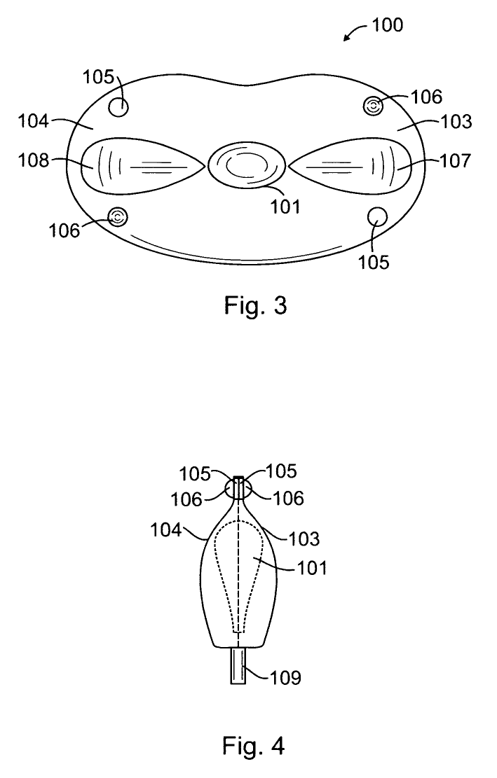

Referring to FIGS. 1 through 4, this Example provides an embodiment of the pacifier with integral protective nipple housing. The pacifier 100 includes a nipple including a first end 101 and a second end 102, the first end 101 including a substantially round shape. The pacifier 100 also includes a generally planar and substantially flexible shield including a top side and a bottom side, the top side of the shield being attached to the second end of the nipple 102, wherein the nipple is generally attached at the center of the top side of the shield, the shield including a right region 103 and a left region 104, the right region 103 and the left region 104 of the shield including one or more means 105 and 106 for reversible attachment to each other, wherein the right region 103 and the left region 104 of the shield are able to be brought in close proximity to each other and surrounding the nipple, whereby the right region 103 and the left region 104 of the shield are able to reversibly attach to each other by way of the one or more means 105 and 106 for reversible attachment providing a covered housing for the nipple as shown in FIG. 4.

This embodiment of the present invention in this Example provides an aperture 105 on the right region 103 and another aperture 105 on the left region 104 of the shield, and also a protruding tab 106 with on the right region 103 and another protruding tab 106 on the left region 104 of the shield as means for reversible attachment in connection of the right region 103 with the left region 104. The protruding tab 106 of the right region 103 being capable of reversibly attaching to the aperture 105 of the left region 104 providing a covered housing for the nipple. In this Example, there are two means of reversible attachment provided for the shield of the pacifier 100 in the form of one protruding tab 106 and one aperture 105 on the right region 103 and another protruding tab 106 and another aperture 105 on the left region 104 of the shield providing a more secure reversible attachment, such that in case one of the means for reversible attachment were to become undone, the second means for attachment would still be in place and continue to provide a covered housing for the nipple.

The shield of the pacifier 100 includes two curved surfaces 107 and 108, with one curved surface 107 located on the right region 103 and another curved surface 108 located on the left region 104 such that when the right region 103 and the left right region 104 of the shield are brought in close proximity to each other, a cavity is formed by the curved surfaces 107 and 108, which can partially or substantially surround the nipple. The pacifier 100 of this Example also includes a handle 109 attached at the bottom side of the shield.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims. Although the invention has been described and illustrated with respect to exemplary embodiments thereof, it should be understood by those skilled in the art that the foregoing and various other changes, omissions, and additions may be made therein and thereto, without parting from the spirit and scope of the present invention.

What is claimed is:

1. A pacifier comprising:
a) a nipple comprising a first end and a second end, said first end comprising a substantially round shape; and
b) a generally planar and substantially flexible shield comprising a top side and a bottom side, said top side of said shield being attached to said second end of said nipple, wherein said nipple is generally attached at the center of said top side of said shield, said shield comprising a right region and a left region, said right region and said left region of said shield comprising one or more means for reversible attachment to each other, wherein said right region and said left right region of said shield are able to be brought in close proximity to each other and substantially surrounding said nipple;
whereby said right region and said left region of said shield are able to reversibly attach to each other by way of said one or more means for reversible attachment providing a covered housing for said nipple.

2. The pacifier of claim 1, further comprising a handle attached at said bottom side of said shield.

3. The pacifier of claim 1, wherein said nipple and said shield comprises a one-piece unitary construction.

4. The pacifier of claim 3, whereby said right region and said left region of said shield are able to reversibly attach to each providing a partially covered or substantially covered housing for said nipple.

5. The pacifier of claim 1, wherein said one or more means for attachment comprises a first protruding tab and a first aperture on said right region of said shield, and a second protruding tab and a second aperture on said left region of said shield, said first protruding tab capable of reversibly attaching to said second aperture and said second protruding tab being capable of reversibly attaching to said first aperture providing a substantially covered housing for said nipple.

6. The pacifier of claim 3, wherein said pacifier is constructed from an elastomeric material.

7. The pacifier of claim 6, wherein said elastomeric material comprises silicone, one or more thermoplastic elastomers, or a combination thereof.

8. The pacifier of claim 1, wherein said shield comprises one or more curved surfaces, such that when said right region and said left right region of said shield are brought in close proximity to each other a cavity is formed partially or substantially surrounding said nipple.

9. A pacifier comprising:
a) a substantially round nipple comprising an elongated body integrally forming a generally planar and substantially flexible shield, said shield comprising a right region and a left region that extend away from said nipple, wherein said right region and said left region are capable of being brought in close proximity to each other and surrounding said nipple; and
b) one or more means for reversible attachment capable of attaching said right region and said left region of said shield to each other providing a covered housing for said nipple.

10. The pacifier of claim 9, further comprising a handle attached to said shield.

11. The pacifier of claim 9, wherein said nipple and said shield comprises a one-piece unitary construction.

12. The pacifier of claim 11, wherein said right region and said left region of said shield are able to reversibly attach to each other providing a partially covered or substantially covered housing for said nipple.

13. The pacifier of claim 11, wherein said one or more means for attachment comprises a first protruding tab and a first aperture on said right region of said shield, and a second protruding tab and a second aperture on said left region of said shield, said first protruding tab capable of reversibly attaching to said second aperture and said second protruding tab being capable of reversibly attaching to said first aperture providing a substantially covered housing for said nipple.

14. The pacifier of claim 11, wherein said pacifier is constructed from an elastomeric material.

15. The pacifier of claim 14, wherein said elastomeric material comprises silicone, one or more thermoplastic elastomers, or a combination thereof.

16. The pacifier of claim 9, wherein said shield comprises one or more curved surfaces, such that when said right region and said left right region of said shield are brought in close proximity to each other a cavity is formed partially or substantially surrounding said nipple.
